(19) United States
(12) Patent Application Publication
(10) Pub. No.: US 2023/0337707 A1
(43) Pub. Date: Oct. 26, 2023

(54) MICROENCAPSULATION WITH PLANT PROTEIN

(71) Applicant: International Flavors & Fragrances, Inc., New York, NY (US)

(72) Inventors: Amir Malaki Nik, Union Beach, NJ (US); Ronald Gabbard, Union Beach, NJ (US); Krishna Raghupathi, Union Beach, NJ (US); Adam Toth, Union Beach, NJ (US)

(21) Appl. No.: 17/793,223

(22) PCT Filed: Jan. 18, 2021
(86) PCT No.: PCT/US2021/013816

§ 371 Date: Jul. 15, 2022

Related U.S. Application Data
(60) Provisional application No. 62/965,404, filed on Jan. 24, 2020.

(51) Int. Cl. A23L 27/00; A23J 3/14

(52) U.S. Cl. CPC A23L 27/72; A23J 3/14

(57) ABSTRACT

An encapsulation particle containing an active material and an unhydrolyzed rice, sunflower, or faba bean protein are provided as is a method of producing the encapsulation particle.

This patent application claims the benefit of priority from U.S. Provisional Application Serial No. 62/965,404 filed Jan. 24, 2020, the contents of which are incorporated herein by reference in their entirety.

### BACKGROUND

Flavors have been used extensively in almost all food products in the market to provide desirable sensorial experience. However, the majority of flavoring compounds are volatile and unstable under conventional food processing conditions. Encapsulation techniques can be used to overcome these issues by protecting the core flavoring compounds during manufacturing and storage. Encapsulation is a process in which an active ingredient is embedded within carrier matrices, which results in protection of core active compounds from the surrounding environment. Spray drying is the most commonly used encapsulation process in the food industry due to its continuous nature and adaptability to industrialization. The spray drying process normally involves an initial emulsification step, in which an emulsifier acts as a stabilizer for the core oil and carbohydrates (e.g., maltodextrins) act as film-forming materials. The emulsion is then converted into a free-flowing powder by spray-drying process. Gum acacia, modified starches, and dairy proteins such as whey proteins and caseinate are the most common emulsifiers and film forming materials used in encapsulation applications (Gharsallaoui, et al. (2007) Food Res. Internat. 40:1107- 1121). Due to market demand for more natural, clean label and sustainable ingredients, the use of plant-based proteins in flavor delivery and encapsulation is of interest.

Soy proteins, pea proteins and potato proteins have been explored in food industry for vegetable oil and flavor encapsulation. See, US 2016/324877, US 2010/0074986, US 9,504,265, US 8,465,911, EP 2827726 B1, EP 2838278 B1, CN 106362653 and WO 2010/090983. Moreover, alkaline hydrolysates of potato proteins have been suggested for use as emulsifiers in food compositions (US 9,149,063 B2). However, limited solubility and emulsification properties have hindered the use of plant-based materials.

### SUMMARY OF THE INVENTION

This invention provides an encapsulation particle composed of (a) an active material; and (b) a matrix material containing an unhydrolyzed rice, sunflower, or faba bean protein and carrier, wherein the encapsulation particle has a diameter of 2 µm to 5000 µm, the active material is dispersed within the matrix material, and the ratio between the active material and the unhydrolyzed rice, sunflower, or faba bean protein is 10:1 to 1:10. In some embodiments, the carrier is present in an amount of 1% to 99% by weight of the encapsulation particle. In other embodiments, the carrier is inulin, maltodextrin, glycose syrup solid, maltose, sucrose, polyol, vegetable fiber or a combination thereof. In still other embodiments, the active material is selected from the group consisting of a fragrance, pro-fragrance, flavor, malodor counteractive agent, vitamin or derivative thereof, anti-inflammatory agent, fungicide, anesthetic, analgesic, antimicrobial active, anti-viral agent, anti-infectious agent, anti-acne agent, skin lightening agent, insect repellant, animal repellent, vermin repellent, emollient, skin moisturizing agent, wrinkle control agent, UV protection agent, fabric softener active, hard surface cleaning active, skin or hair conditioning agent, flame retardant, antistatic agent, taste modulator, cell, probiotic, colorant, vegetable oil, and combinations thereof. Preferably, the active material is present in an amount of 0.1% to 60% by weight of the encapsulation particle; and the unhydrolyzed rice, sunflower, or faba bean protein is present in an amount of 0.1% to 99% by weight of the encapsulation particle.

This invention also provides a method for producing an encapsulation particle, which includes the steps of (a) emulsifying an active material (e.g., a flavor), an unhydrolyzed rice, sunflower, or faba bean protein and a carrier to obtain a homogeneous aqueous slurry, wherein the active material and the unhydrolyzed rice, sunflower, or faba bean protein are provided at a ratio of 10:1 to 1:10; and (b) drying the homogeneous aqueous slurry, e.g., by spray drying, freeze drying, spray chilling, fluidized bed drying, drum drying, vacuum drying, film drying, belt drying, conduction drying, infrared drying, or a combination thereof.

### DETAILED DESCRIPTION OF THE INVENTION

It has now been found that rice, sunflower, or faba bean proteins are of use as natural and functional wall materials for the encapsulation of volatile compounds. In particular, it has now been demonstrated that rice, sunflower, or faba bean protein, specifically unhydrolyzed rice, sunflower, or faba bean protein, facilitates encapsulation of oil-based flavors. Accordingly, this invention provides encapsulation particles having a plurality of oil droplets composed of an active material to be encapsulated, e.g., a flavor, and a solid matrix composed of a rice, sunflower, or faba bean protein alone or in combination with a carrier, e.g., a low molecular weight carbohydrate carrier. This invention finds use in the production of natural liquid and dry flavor delivery systems suitable for a broad range of commercial applications. Advantageously, this invention allows for the replacement of synthetic emulsifiers with a natural, sustainably produced emulsifier without significantly sacrificing product performance.

In accordance with this invention, active materials are preferably encapsulated within a matrix composed of unhydrolyzed rice, sunflower, or faba bean protein and a carrier. Thus, this invention provides an encapsulated particle comprising, consisting of, or consisting essentially of (a) an active material, and (b) a matrix containing an unhydrolyzed rice, sunflower, or faba bean protein and carrier, wherein the active material is dispersed within the matrix. Matrices of the invention encapsulate active materials (e.g., flavors or fragrances) in a discontinuous phase of inclusions of oil dispersed within a continuous phase of matrix material. The oil may be used as a solvent for the active, or may be an active in its own right. Encapsulation particles may have a spherical shape, but also may be a shape other than spherical. Particle sizes may vary depending on the method of production, e.g., spray drying or printing. In this respect, encapsulation particles of this invention have a diameter in the range of 0.2 µm to 5000 µm (e.g., 0.5 µm to 120 µm, 2 µm to 500 µm, 2 µm to 300 µm, 2 µm to 150 µm, 100 µm to 1000 µm, 500 µm to 5000 µm, 1000 µm to 5000 µm, 1000 µm to 4000 µm, and 1000 µm to 2000 µm) .

As a first emulsifier, this invention provides for the use of an unhydrolyzed rice, sunflower, or faba bean protein. As used herein, an “unhydrolyzed” rice, sunflower, or faba bean protein refers to a protein that has not been hydrolyzed or broken down, partially or completely, into smaller polypeptides, peptides, or its component amino acids by, for example, an acid (e.g., a strong acid such as p-toluenesulphonic acid or hydrochloric acid) or base (e.g., sodium hydroxide), or using an enzyme (e.g., trypsin, chymotrypsin, pepsin, ficin, etc.). Unhydrolyzed proteins include denatured rice, sunflower, or faba bean proteins and native (or undenatured) rice, sunflower, or faba bean proteins. “Denatured protein” refers to a protein whose native secondary, tertiary or quaternary structure and/or chemical and/or biological properties have been altered by application of some external stress or compound such as an acid (e.g., acetic acid or trichloroacetic acid) or base (e.g., sodium bicarbonate or sodium sulphate), a concentrated inorganic salt (e.g., calcium chloride), an organic solvent (e.g., alcohol, ether, acetone or chloroform), UV radiation or heat without hydrolyzing the protein. “Native” rice, sunflower, or faba bean protein is defined as protein isolated from rice, sunflower, or faba bean without any significant physical or (bio)chemical modification or inactivation, in particular denaturation or hydrolysis.

Rice proteins are categorized into four protein fractions including albumin (water-soluble), globulin (salt-soluble), glutelin (alkali/acid-soluble), and prolamin (alcohol-soluble) (Shih (2003) Nahrung/Food 47(6):420-424). The rice protein fractions may vary, depending on the rice variety and the extraction procedures. A singular feature of rice is that prolamin, which represents the major endosperm storage protein in other cereals with the exception of oats (Shewry & Halford, (2002) J. Exp. Bot. 53:947-958), is a minor protein in all rice grain milling fractions, whereas glutelin is the dominant protein in brown and milled rice. The proportion of albumin, globulin, glutelin and prolamin has been reported to be 5% to 10%, 7% to 17%, 75% to 81%, and 3% to 6%, respectively, in brown rice; and 4% to 6%, 6% to 13%, 79% to 83%, and 2% to 7%, respectively, in milled rice (Agboola, et al. (2005) J. Cereal Sci. 41:283-290; Cao, et al. (2009) J. Cereal Sci. 50:184-189; Ju, et al. (2001) J. Food Sci. 66:229-232; Zhao, et al. (2012) J. Cereal Sci. 56:568-575).

The unhydrolyzed rice protein of this invention may be obtained from any suitable source or Oryza sativa including brown rice, white rice, or black (or purple) rice, as well as sprouted versions of the same. In some embodiments, the unhydrolyzed rice protein contains one or more of albumin, globulin, glutelin, and prolamin. In addition, the rice protein used in this invention preferably has a protein content of at least 70%, 75%, 80%, 85% or 90%. Exemplary unhydrolyzed rice proteins are commercially available from a number of sources and include, but are not limited to, rice proteins sold under the tradenames Oryzatein® 80 (80% protein) and Oryzatein® 90 (90% protein) by Axiom Foods, Inc. (Los Angeles, CA); AdvantaRice™ (sprouted brown rice) and RisaPRO™ (80% protein) sold by AIDP (City of Industry, CA); Purple Rice (black rice) protein (>70% protein) sold by Bioway Organic Ingredients Co., Ltd (China); and brown rice protein sold by Ingredients Inc (Buffalo Grove, IL).

The unhydrolyzed sunflower protein of this invention is preferably obtained from sunflower seed (Helianthus annuus), as well as sprouted versions of the same. On a dry basis, sunflower seeds contain between 20 and 40 percent protein. Defatted sunflower meal is often around 30 percent protein, but can reach levels as high as 53 to 66 percent when extracted using an organic solvent. Besides having low lysine content, sunflower protein meets all other amino acid requirements. Sunflower protein contains about 20 percent branched-chain amino acids. Sunflower protein has relatively good solubility over a range of ionic strength and pH. Exemplary unhydrolyzed sunflower proteins are commercially available from a number of sources and include, but are not limited to, sunflower protein sold under the tradenames Heliaflor® 45 Sunflower Protein (45% dry weight protein) and Heliaflor® 55 Sunflower Protein (55% dry weight protein) sold by Austrade Inc. (Palm Beach Gardens, FL) and Organic Sunflower Protein Powder sold by Bioway Organic Ingredients Co., Ltd (China).

Faba bean, also known as Vicia faba, broad bean, fava bean, field bean, bell bean, or tic bean, is a species of bean (Fabaceae) native to North Africa, Southwest and South Asia, and extensively cultivated also elsewhere. In 100 grams of faba bean there is about 58.29 grams of carbohydrates, 25 grams of fibers, 1.53 gram of fat and 26.12 grams of protein. Exemplary unhydrolyzed faba bean proteins are commercially available from a number of sources and include, but are not limited to, faba bean protein sold under the tradename Vitessence™ Pulse 3600 or Vitessence™ Pulse CT 3602, which are composed of 60% protein (Ingredion, Westchester, IL); and 60% and 80% faba bean protein powders sold by BI Nutraceuticals (Rancho Dominguez, CA).

In accordance with this invention, the unhydrolyzed rice, sunflower, or faba bean protein of an encapsulation particle is present in an amount of 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 99% by dry weight of an encapsulation particle described herein or in a range between any combination of these amounts. Ideally, the unhydrolyzed rice, sunflower, or faba bean protein is present in an amount of from 0.1% to 60% by weight of the encapsulation particle or more preferably 1% to 30% or most preferably 5% to 20% by dry weight of an encapsulation particle.

Carriers of use in the matrix are preferably solid carriers such as mono-, di- or oligosaccharides, e.g., glucose, fructose, sucrose, maltose, lactose, trehalose, raffinose, cellobiose, and the like; polysaccharides, e.g., maltodextrin, inulin (from chicory root, Jerusalem artichoke, blue agave, garlic or onion) and the like; mixtures of carbohydrates, e.g., glycose syrup solids; a vegetable fiber, e.g., cellulose or starch; polyols such as sorbitol, mannitol, maltitol, lactitol, xylitol, isomalt, erythritol; or a combination thereof. In some embodiments, the average molecular weight of the carrier is less than 10000 g/mol, or more preferably less than 8000 g/mol.

In some embodiments, the carrier is one or a combination of inulins. In particular embodiments, the carrier is inulin isolated from chicory root, Jerusalem artichoke and/or blue agave. Inulin is a soluble polyfructan and belongs to a group of dietary fiber. Inulin chains are composed of up to 100 D-fructofuranose units linked via β-(2-->1) glycosidic bonds (Galazka (2002) Źywność Nauka, Technologia, Jakość 3(32):S37-S45). In terms of physicochemical properties, inulins exhibit good water solubility, low viscosity at high solids contents, and good film forming properties which are of particular importance for spray drying encapsulation.

The carrier may be present in the encapsulation particle in an amount of 1%, 5%, 10%, 20%, 30%, 40%, 50%, 60%, 70%, 80%, 90% or 99% by dry weight of the encapsulation particle or in a range between any combination of these amounts. In certain embodiments, the carrier is present in the encapsulation particle in an amount in the range of 10% to 95% by dry weight of the encapsulation particle or more preferably 10% to 90% by dry weight of an encapsulation particle.

In accordance with this invention, the matrix material encapsulates an oil phase including one or more active materials. An active material of use in this invention includes, but is not limited to, a fragrance, pro-fragrance, flavor, malodor counteractive agent, vitamin or derivative thereof, anti-inflammatory agent, fungicide, anesthetic, analgesic, antimicrobial active, anti-viral agent, anti-infectious agent, anti-acne agent, skin lightening agent, insect repellant, animal repellent, vermin repellent, emollient, skin moisturizing agent, wrinkle control agent, UV protection agent, fabric softener active, hard surface cleaning active, skin or hair conditioning agent, flame retardant, antistatic agent, taste modulator, cell, probiotic, colorant, pigment, antioxidant, vegetable oil (e.g., soy, sunflower, safflower, olive, corn, avocado or grapeseed oil), or a combination thereof.

Fragrances include, for example, benzaldehyde, benzyl acetate, cis-3-hexenyl acetate, cis-jasmone, coumarin, dihydromyrcenol, dimethyl benzyl carbinyl acetate, ethyl vanillin, eucalyptol, eugenol, iso eugenol, isobutyl salicylate, flor acetate, geraniol, hydroxycitronellal, koavone, LIFFAROME, dihydro linalool, linalool, methyl anthranilate, methyl beta naphthyl ketone, methyl dihydro jasmonate, nerol, nonalactone, orange flower ether, phenyl ethyl acetate, phenyl ethyl alcohol, phenyl propyl alcohol, phenoxy ethyl isobutyrate, phenoxanol, alpha terpineol, tetrahydro linalool, beta terpineol, vanillin, and the like.

Suitable flavors include, for example, fruit flavors, such as guava, kiwi, peach, mango, papaya, pineapple, banana, strawberry, raspberry, blueberry, orange, grapefruit, tangerine, lemon, lime, lemon-lime, etc.; tea flavors; coffee flavors; chocolate flavors; dairy flavors; methyl salicylate (wintergreen oil, sweet birch oil), nutmeg, bergamot cinnamon, cassia, neroli, coriander, lavender, and other flavors described herein.

Vitamins include any vitamin, a derivative thereof and a salt thereof. Examples include vitamin A and its analogs and derivatives (e.g., retinol, retinal, retinyl palmitate, retinoic acid, tretinoin, and iso-tretinoin, known collectively as retinoids), vitamin E (tocopherol and its derivatives), vitamin C (L-ascorbic acid and its esters and other derivatives), vitamin B3 (niacinamide and its derivatives), alpha hydroxy acids (such as glycolic acid, lactic acid, tartaric acid, malic acid, citric acid, etc.) and beta hydroxy acids (such as salicylic acid and the like) .

Dyes, colorants or pigments include, e.g., lactoflavin (riboflavin), beta-carotene, riboflavin-5′-phosphate, alpha-carotene, gamma-carotene, cantaxanthin, erythrosine, curcumin, quinoline yellow, yellow orange S, tartrazine, bixin, norbixin (annatto, orlean), capsanthin, capsorubin, lycopene, beta-apo-8′-carotenal, beta-apo-8′-carotenic acid ethyl ester, xantophylls (flavoxanthin, lutein, cryptoxanthin, rubixanthin, violaxanthin, rodoxanthin), fast carmine (carminic acid, cochineal), azorubin, cochineal red A (Ponceau 4 R), beetroot red, betanin, anthocyanins, amaranth, patent blue V, indigotine I (indigo-carmine), chlorophylls, copper compounds of chlorophylls, acid brilliant green BS (lissamine green), brilliant black BN, vegetable carbon, titanium dioxide, iron oxides and hydroxides, calcium carbonate, aluminum, silver, gold, pigment rubine BK (lithol rubine BK), methyl violet B, victoria blue R, victoria blue B, acilan brilliant blue FFR (brilliant wool blue FFR), naphthol green B, acilan fast green 10 G (alkali fast green 10 G), ceres yellow GRN, sudan blue II, ultramarine, phthalocyanine blue, phthalocayanine green, fast acid violet R. Further naturally obtained extracts (for example paprika extract, black carrot extract, red cabbage extract) can be used for coloring purposes.

Examples of antioxidants include carotenoids (e.g., beta-carotene), vitamin C (Ascorbic Acid) or an ester thereof, citric acid, vitamin A or an ester thereof, tocopherols (e.g., vitamin E or an ester thereof), lutein or an ester thereof, lycopene, selenium, flavonoids, vitamin-like antioxidants such as coenzyme Q10 (CoQ10) and glutathione, phenolic acids and their esters, rosemary extract, curcumin and antioxidant enzymes such as superoxide dismutase (SOD), catalase and glutathione peroxidase, as well as butylated hydroxyanisole (BHA), butylated hydroxytoluene (BHT), propyl gallate or tert-butylhydroquinone (TBHQ).

Anti-inflammatory agents include, e.g., methyl salicylate, aspirin, ibuprofen, and naproxen. Additional anti-inflammatories include corticosteroids, such as, but not limited to, flurandrenolide, clobetasol propionate, halobetasol propionate, fluticasone propionate, betamethasone dipropionate, betamethasone benzoate, betamethasone valerate, desoximethasone, dexamethasone, diflorasone diacetate, mometasone furoate, halcinonide, fluocinonide, fluocinolone acetonide, desonide, triamcinolone acetonide, hydrocortisone, hydrocortisone acetate, fluoromethalone, methylprednisolone, and predinicarbate.

Anesthetics include benzocaine, butamben, butamben picrate, cocaine, procaine, tetracaine, lidocaine and pramoxine hydrochloride.

Suitable analgesics include, but are not limited to, ibuprofen, diclofenac, capsaicin, and lidocaine.

Non-limiting examples of anti-fungal agents include micanazole, clotrimazole, butoconazole, fenticonasole, tioconazole, terconazole, sulconazole, fluconazole, haloprogin, ketonazole, ketoconazole, oxinazole, econazole, itraconazole, torbinafine, nystatin and griseofulvin.

Non-limiting examples of antibiotics include erythromycin, clindamycin, synthomycin, tetracycline, metronidazole and the like.

Anti-viral agents include, but are not limited to, famcyclovir, valacyclovir and acyclovir.

In certain embodiments, the active material is a flavor. Flavors contemplated by the present invention include any liquid flavoring which is of food acceptable quality. The flavor may be an essential oil, synthetic flavor, reaction flavor, or mixtures thereof including but not limited to oils derived from plants and fruits such as lemon, berry, orange, grapefruit, tangerine, lime, kumquat, mandarin, bergamot, citrus oils, fruit essences, peppermint oil, spearmint oil, clove oil, oil of wintergreen, anise, and the like. Artificial flavoring components are also contemplated by this invention.

Preferred flavors include, but are not limited to, anise oil; ethyl-2-methyl butyrate; vanillin; cis-3-heptenol; cis-3-hexenol; trans-2-heptenal; butyl valerate; 2,3-diethyl pyrazine; methyl cyclo-pentenolone; benzaldehyde; valerian oil; 3,4-dimethoxy-phenol; amyl acetate; amyl cinnamate; Y-butyryl lactone; furfural; trimethyl pyrazine; phenyl acetic acid; isovaleraldehyde; ethyl maltol; ethyl vanillin; ethyl valerate; ethyl butyrate; cocoa extract; coffee extract; peppermint oil; spearmint oil; clove oil; anethol; cardamom oil; wintergreen oil; cinnamic aldehyde; ethyl-2-methyl valerate; γ-hexenyl lactone; 2,4-decadienal; 2,4-heptadienal; methyl thiazole alcohol (4-methyl-5-β-hydroxyethyl thiazole); 2-methyl butanethiol; 4-mercapto-2-butanone; 3-mercapto-2-pentanone; 1-mercapto-2-propane; benzaldehyde; furfural; furfuryl alcohol; 2-mercapto propionic acid; alkyl pyrazine; methyl pyrazine; 2-ethyl-3-methyl pyrazine; tetramethyl pyrazine; polysulfides; dipropyl disulfide; methyl benzyl disulfide; alkyl thiophene; 2,3-dimethyl thiophene; 5-methyl furfural; acetyl furan; 2,4-decadienal; guiacol; phenyl acetaldehyde; β-decalactone; d-limonene; acetoin; amyl acetate; maltol; ethyl butyrate; levulinic acid; piperonal; ethyl acetate; n-octanal; n-pentanal; n-hexanal; diacetyl; monosodium glutamate; monopotassium glutamate; sulfur-containing amino acids, e.g., cysteine; hydrolyzed vegetable protein; 2-methylfuran-3-thiol; 2-methyldihydrofuran-3-thiol; 2,5-dimethylfuran-3-thiol; hydrolyzed fish protein; tetramethyl pyrazine; propylpropenyl disulfide; propylpropenyl trisulfide; diallyl disulfide; diallyl trisulfide; dipropenyl disulfide; dipropenyl trisulfide; 4-methyl-2-[(methyl-thio)-ethyl]-1,3-dithiolane; 4,5-dimethyl-2-(methylthiomethyl)-1,3-dithiolne; and 4-methyl-2-(methylthiomethyl)-1,3-dithiolane. These and other flavor ingredients are provided in U.S. Pat. Nos. 6,110,520 and 6,333,180, each of which is incorporated herein by reference.

An active material of an encapsulation particle is present in an amount of 0.1%, 0.5%, 1%, 10%, 15%, 20%, 25%, 30%, 35%, 40%, 45%, 50%, 55% or 60% by weight of the encapsulation particle described herein or in a range between any combination of these amounts. Ideally, the active material is present in an amount of from 0.1% to 65%, or more preferably 1% to 60% by dry weight of the encapsulation particle.

The ratio of active material (e.g., flavor) to unhydrolyzed rice, sunflower, or faba bean protein in the compositions herein is ideally 10:1, 9:1, 8:1, 7:1, 6:1, 5:1, 4: 1, 3: 1, 2:1, 1: 1, 1:2, 1:3, 1: 4, 1: 5, 1:6, 1:7, 1:8, 1:9 or 1:10 by weight of the composition or in a range between any combination of these ratios. In some embodiments, the active material and unhydrolyzed rice, sunflower, or faba bean protein are present in an encapsulation particle at a weight ratio in the range of 10:1 to 1:10, preferably 5:1 to 1:5, or more preferably in the range of 2:1 to 1:2, by weight of the composition. In certain embodiments, the ratio of active material (e.g., flavor) to unhydrolyzed rice, sunflower, or faba bean protein is at least 4:1. In other embodiments, the ratio of active material (e.g., flavor) to unhydrolyzed rice, sunflower, or faba bean protein is at least 2:1.

Depending on the active material and application, the compositions herein may include additional components such as a salt and/or an antioxidant, which do not materially affect the process of encapsulation of the active material with the carrier. Examples of salts include, but are not limited to sodium chloride, potassium chloride, magnesium chloride and the like. Antioxidants include for example carotenoids (e.g., beta-carotene), vitamin C (Ascorbic Acid) or an ester thereof, citric acid, vitamin A or an ester thereof, tocopherols (e.g., vitamin E or an ester thereof), lutein or an ester thereof, lycopene, selenium, flavonoids, vitamin-like antioxidants such as coenzyme Q10 (CoQ10) and glutathione, phenolic acids and their esters, rosemary extract, curcumin and antioxidant enzymes such as superoxide dismutase (SOD), catalase and glutathione peroxidase, as well as butylated hydroxyanisole (BHA), butylated hydroxytoluene (BHT), propyl gallate or tert-butylhydroquinone (TBHQ).

The encapsulation particle of the invention is produced by (a) mixing an active material, an unhydrolyzed rice, sunflower, or faba bean protein and a carrier to obtain a homogeneous aqueous slurry, wherein the slurry has a pH of 1 to 10 (preferably a pH of 4 to 7, and the active material and the unhydrolyzed rice, sunflower, or faba bean protein are provided at a ratio of 10:1 to 1:10; and (b) drying the aqueous flavor slurry thereby producing an encapsulation particle.

As used herein, a “homogeneous aqueous slurry” refers to a mixture of two liquids, wherein one liquid (the dispersed phase) is evenly dispersed in an aqueous liquid (the continuous phase). Preferably, the dispersed phase an oil phase containing the active material. A homogeneous aqueous slurry is suitably prepared by bringing into association the active material and an aqueous phase containing the unhydrolyzed rice, sunflower, or faba bean protein and carrier to form a mixture; and homogenizing the mixture to form an emulsion or slurry composed of a plurality of oil droplets (e.g., flavor droplets) dispersed in the continuous aqueous phase. Homogenizing, as used herein, refers to a process whereby the aqueous phase and oil phase are transformed into a stable emulsion or slurry of oil phase droplets within the continuous aqueous phase. In some embodiments, the emulsion or slurry is made by first dispersing the oil phase in the aqueous phase with the unhydrolyzed rice, sunflower, or faba bean protein and carrier dissolved in the aqueous phase using a high shear mixer, for example a Silverson L4R type mixer and/or Silverson Verso line rotor-stator mixer). Desirably, the emulsion or slurry forms droplets having a mean diameter of from of 0.1 µm to 20 µm.

Any suitable method for drying the emulsion or slurry can be used including, but not limited to spray drying, freeze drying, spray chilling, fluidized bed drying, drum drying, vacuum drying, film drying, belt drying, conduction drying, infrared drying, or a combination thereof. See, e.g., US 20150267964 A1, US 20150284189 A1, and US 20160097591 A1. Depending on the drying method selected, the viscosity of the emulsion or slurry may be in the range of 100 cps to 10000 cps. In embodiments pertaining to spray drying, preferably the viscosity of the emulsion or slurry is in the range of 100 cps to 1000 cps.

Upon drying, the moisture content of the dried encapsulation particle is preferably less than 10% or more preferably less than 5%. Ideally, the water activity of the dried encapsulation particle is less than 0.5, or more preferably less than 0.4, or most preferably less than 0.3.

As demonstrated herein, encapsulated particles prepared with rice, sunflower, or faba bean protein and inulin as matrix materials were highly water dispersible and therefore suitable for use in various food applications. Notably, the flavor oil recovery and encapsulation efficiencies were high. In particular, volatile compound recoveries were as high as 70% to 100% (depending on the compound) and encapsulation efficiencies were at least 80%. Moreover, the encapsulated particles exhibited low or undetectable surface oil. In addition, the shelf life of the encapsulated particles was at least 18 months. Therefore, rice, sunflower, or faba bean protein in combination with a carbohydrate carrier provides a natural, sustainable flavor delivery system of use in food, beverage, pharmaceutical, cosmetic, nutraceutical, supplement, additive, personal care, consumer product, agrochemical, veterinary medicine, and chemical industries.

The following non-limiting examples are provided to further illustrate the present invention.

### Example 1: Materials and Methods

Brown rice protein with 80% protein content (according to supplier) was provided by Ingredients Inc. (Buffalo Grove, IL). Inulins derived from blue agave and from chicory root (sold under the tradename ORAFTI® GR) were obtained from Ciranda (Hudson, WI) and Beneo (Belgium), respectively. All the flavors used in this invention were provided by International Flavors & Fragrances Inc (Union Beach, NJ).

Preparation of Encapsulated Flavor Powders. An aqueous flavor slurry was prepared by mixing the rice protein and inulin in water at ambient temperature using an overhead mixer at 500 rpm for 1 hour or until solid materials were fully dissolved. The aqueous flavor slurry was then cooled to approximately 15° C. The flavor was added into the aqueous flavor slurry followed by mixing using a Silverson Verso in line rotor-stator mixer at 2500 rpm with a circulation rate of 1 Kg per minute. The aqueous flavor slurry was dried using a pilot scale Anhydro MicraSpray MS-400 spray dryer connected to a fluid bed unit for additional agglomeration and water evaporation. The inlet air temperature of the spray dryer was adjusted to approximately 95° C., and the outlet temperature was kept at approximately 55° C. by controlling the flow rate. Two fluid nozzle atomizers were used to atomize the aqueous flavor slurry inside the dryer at a feed rate of 10 kg/hour and air flow rate of 200 cubic feet/minute. In order to maintain homogeneity, the slurry was gently stirred while being fed into the spray dryer. The finished flavor encapsulated powder was collected in the cyclone collection vessel and stored in a sealed aluminum bag at -5° C. until analyzed.

Viscosity Measurement of Slurry. The apparent viscosity of feed slurries was measured using a Brookfield viscometer using spindles #4 at 60 RPM.

Droplet and Particle Size Measurements. The droplet size distribution of the flavors was measured using a Beckman Coulter LS 13 320 Laser Diffraction Particle Size Analyzer. Distilled water was used as the dispersant. The powder particle size distributions of the microcapsules were measured using a Mastersizer 3000 laser light scattering instrument (Malvern Instruments Ltd., Worcestershire, United Kingdom) equipped with a powder sample handling unit. Droplet/particle distributions were calculated by the instrument according to the Mie Theory, which uses the refractive index difference between the droplets and the dispersing medium to predict the intensity of the scattered light. Droplet /particle size measurements were reported as volume-surface mean diameters or D[4,3].

Water Activity Measurements. The water activity was measured using an AQUALAB 4TEV water activity meter (Decagon Devices, Inc., Pullman, WA). Samples were placed in a disposable sample cup, completely covering the bottom of the cup. The sample cup was then loaded into the instrument for measurement. At a minimum, duplicate measurements were carried out and the average of these measurements are reported herein.

Microcapsule Surface and Total Oil Measurements. Samples were placed into a 4 dram vial and the exact weight was recorded. To the sample was added 6.7 g (approx. 10 mL) of hexane and the exact weigh was again recorded. The sample was placed onto a tube rotator for 10 minutes. An aliquot of the sample was filtered with a 0.45 µm nylon syringe filter into an autosampler vial. The surface oil was measured using a gas chromatographic (GC) instrument equipped with a flame ionization detector and quantified using standard solutions. Surface oil represents the portion of oil present on the surface of the microcapsule (Bao, et al. (2011) J. Food Sci. 76:E112-8). Total oil content of the microcapsules was determined based on calculation of total volatile retention, as described below. Encapsulation efficiency was calculated as follows: (total oil content - surface oil)/total oil content × 100%.

Flavor Volatile Retention Measurements. The amount of individual aroma compounds retained in flavor encapsulated powders was determined by gas chromatographic (GC) analysis. Approximately 1.0 gram of spray dry powder was weighted into a 50 ml centrifuge tube. Subsequently, 5 mL of deionized water was added to the tube and the sample was vortexed at high speed for 1 minute to dissolve or homogenize the sample. Once the sample was totally dissolved, 5 ml of extraction solvent (acetonitrile containing 0.05% ethyl valerate as internal standard) was pipetted into the same tube, and the sample was vortexed at high speed for 1 minute. Anhydrous magnesium sulfate (4.0 g) was subsequently added to the sample mixture, and the mixture was vortexed immediately at high speed for 1 minute. The tubes were then centrifuged and the clear extract was transferred to a 2 mL screw-cap vial and analyzed by GC/FID (Agilent 6850 or equivalent). Concentrations of individual aroma compounds (mg/g powder) in each spray dried powder were determined via linear regression (R2 > 0.99) obtained from 3-point calibration curves using neat oil, which went through the same extraction procedure. Target flavor components are identified using both retention indices and/or mass spectrometry. The aroma retentions of the individual compounds were expressed as a percentage of their initial amount in the flavor powders.

### Example 2: Encapsulation of Tomato Flavor in Rice Protein

Tomato flavor was encapsulated using rice proteins combined with low molecular weight carbohydrate. In this example, a blend of two types of inulin (derived from blue agave and chicory root) were used as a matrix material along with rice protein to improve the encapsulation efficiency. Tomato flavor slurry was prepared with the materials listed in Table 1. The matrix materials were first dissolved in water to form an aqueous solution followed by cooling to approximately 15° C. Tomato flavor was mixed into the aqueous solution using a Silverson high shear mixture at 6000 rpm for 5 minutes. The flavor slurry was then homogenized using a Silverson Verso in line rotor-stator mixer at 2500 rpm and circulation rate of 1 Kg per min. The flavor slurry was subsequently spray dried using a pilot scale Anhydro MicraSpray MS-400 spray dryer with a centrifugal atomizer installed. The inlet temperature was approximately 95° C. and the outlet temperature was approximately 55° C. The flow rate was kept at about 50 mL/minute.

TABLE 1

| Material | Gram |
|---|---|
| Rice Protein | 600 |
| Blue Agave Inulin | 3986 |
| Chicory Root Inulin | 1340 |
| Tomato Flavor | 73.2 |
| Water | 4000 |

Table 2 summarizes the physicochemical properties of tomato flavor encapsulated powder.

TABLE 2

Physicochemical Properties

| Flavor emulsion mean droplet size | <10 µm |
|---|---|
| Flavor emulsion viscosity | 453 cps |
| Microcapsule mean particle size | 54 µm |
| Microcapsule water activity | 0.277 |
| Microcapsule free oil | trace |
| Encapsulation Efficiency | 88.0% |

The tomato flavor microcapsules showed an encapsulation efficiency of 88% and very low amount of surface oil (trace) indicating that rice proteins in combination with inulins were able to produce a tomato flavor encapsulated powder with strong encapsulation efficiency. In addition to total encapsulation efficiency, the volatile retention of individual flavoring compounds present in a flavor is an important indicator of flavor profile after spray drying process. Accordingly, the main flavoring compounds of the tomato flavor were measured (Table 3).

TABLE 3

| Compound | Retention (%) |
|---|---|
| E-2, hexenal | 32.6 |
| Hexenol, B gamma | 104.2 |
| Iso Buty Thiazole | 98.5 |
| Methional | 81.3 |
| Damasenone | 97.7 |
| Phenyl ethyl alc | 96.1 |
| Ionone, beta | 102.1 |
| Eugenol | 103.2 |
| Dimethyl sulfide | 71.6 |

Overall, most of the flavoring compounds showed strong retention after the spray drying process (Table 3). Dimethyl sulfide which is the most volatile compound in tomato flavor, with a molecular weight of 62.13 g/mol and vapor pressure of 402 mmHg, also showed relatively strong retention (71.6%). Among all the compounds, (E) -2-hexenal showed the lowest retention with 32.6%. This result is consistent with previously reported losses of (E)-2-hexenal, which are primarily due to its relatively small molecular size (98.14 g/mol) and high vapor pressure (4.72 mmHg) (Bangs _{&} Reineccius (1981) J. Food Sci. 47:254-259).

### Example 3: Encapsulation of Basil Flavor in Rice Protein

Basil flavor was encapsulated using rice proteins combined with inulins (Table 4). A flavor slurry was prepared by dissolving the matrix materials in water followed by cooling to 15° C. Basil flavor was mixed into the aqueous solution containing the matrix materials using a Silverson high shear mixture at 6000 rpm for 5 minutes. The flavor slurry then homogenized using a Silverson Verso in line rotor-stator mixer at 2500 rpm and circulation rate of 1 Kg per minute. The flavor slurry was then dried using a pilot scale Anhydro MicraSpray MS-400 spray dryer with a centrifugal atomizer installed. The inlet temperature was approximately 95° C. and the outlet temperature was approximately 55° C. The flow rate was kept at 50 mL/minute.

TABLE 4

| Material | Gram |
|---|---|
| Rice Protein | 1200 |
| Blue Agave Inulin | 2700 |
| Chicory Root Inulin | 1200 |
| Basil Flavor | 900 |
| Water | 4000 |

The physiochemical properties of basil flavor encapsulated powder are summarized in Table 5.

TABLE 5

| Flavor emulsion mean droplet size | 14 µm |
|---|---|
| Flavor emulsion viscosity | 886 cps |
| Microcapsule mean particle size | 51 µm |
| Microcapsule water activity | 0.173 |
| Microcapsule free oil | trace |
| Encapsulation Efficiency | 85.1% |

Basil flavor encapsulated powder showed an encapsulation efficiency of 85.1% and undetectable surface oil indicating that rice proteins can efficiently encapsulate and protect a high load of basil flavor in the form of spray dried powder. In addition, Table 6 shows the volatile retention of main flavoring compounds in basil flavor. As reported, all compounds showed strong retention with above 80% after the spray drying process.

TABLE 6

| Compounds | Retention (%) |
|---|---|
| Eucalyptol | 83.2 |
| Linalool | 85.8 |
| Eugenol | 88.8 |
| T-Cadinol | 85.8 |

### Example 4: Encapsulation of a Reaction Flavor in Rice Protein

Rice proteins were used as a natural carrier for a chicken reaction flavor spray drying application. A flavor emulsion was prepared with the materials listed in Table 7. The matrix materials were first dissolved in water followed by heating of the slurry to 50-55° C. The reaction flavor was subsequently mixed into the aqueous solution using a Silverson high shear mixture at 6000 rpm for 5 minutes. While maintaining the temperature at 50-55° C., the flavor slurry was homogenized using a Silverson Verso in line rotor-stator mixer at 2500 rpm and circulation rate of 1 Kg per minute. The flavor slurry was then spray dried using pilot scale Anhydro MicraSpray MS-400 spray dryer. The inlet temperature was approximately 190° C. and the outlet temperature approximately 90° C.

TABLE 7

| Material | Gram |
|---|---|
| Rice Protein | 200 |
| Salt | 500 |
| Chicory Root Inulin | 300 |
| Chicken reaction flavor | 1600 |
| Water | 2400 |

Table 8 summarizes the physicochemical properties of chicken reaction dry powder.

TABLE 8

| Flavor emulsion mean droplet size | <10 µm |
|---|---|
| Flavor emulsion viscosity | 180 cps |
| Microcapsule mean particle size | 51.7 µm |
| Microcapsule water activity | 0.034 |

The products described herein in Examples 2-4 were free flowing powders that were highly water dispersible and suitable for various food applications. Overall, the flavor oil recovery and encapsulation efficiencies were high with low or undetectable surface oil. The shelf-life of all the produced flavor powders was tested to be at least 18 months. Sensory evaluations of the flavor powders were conducted using a trained panel and were also shown to provide a very strong and desirable flavor profiles with no significant off taste or off note.

### Example 5: Encapsulation of a Reaction Flavor in Faba Bean Protein

A combination of faba bean protein along with salt and Chicory root inulin were used as a natural carrier to convert a paste-like reaction flavor into a free-flowing powder using a spray drying process. A flavor feed slurry was prepared from the materials listed in Table 9. The Chicken reaction flavor was first diluted with water to prepare a flavor slurry. The dry ingredients were subsequently dissolved into the flavor slurry using an over-head mixer. The slurry was heated to 50-55° C. to ensure all the fat present in reaction flavor was fully melted. The mixture was then subjected to high shear mixing at 6000 rpm for 5 minutes using a Silverson high-shear mixture follow by homogenization using a Silverson Verso in line rotor-stator mixer at 2500 rpm and circulation rate of 1 Kg per minute. The flavor slurry was then spray dried using a pilot scale Anhydro MicraSpray MS-400 spray dryer with a centrifugal atomizer installed and 190° C. inlet and 90° C. outlet temperatures.

TABLE 9

| Material | Gram |
|---|---|
| Faba Protein | 200 |
| Salt | 500 |
| Chicory Root Inulin | 300 |
| Chicken reaction flavor | 1600 |
| Water | 2400 |

The physicochemical properties of the spray dried chicken flavor are summarized in Table 10. The flavor powder prepared using faba bean protein along with chicory root inulin and salt processed well with no process issues and showed parameters within favorable ranges for spray drying process.

TABLE 10

| Flavor emulsion mean droplet size | <10 µm |
|---|---|
| Flavor emulsion viscosity | 23 cps |
| Microcapsule mean particle size | 20.8 µm |
| Microcapsule water activity | 0.094 |

### Example 6. Encapsulation of a Reaction Flavor in Sunflower Protein

A combination of sunflower protein, salt and Chicory root inulin were used as a natural carrier to spray dry a chicken boiled reaction flavor (Table 11). The Chicken reaction flavor used in this example contained approximately 30% water and had a paste-like texture. The flavor was first diluted with water to prepare a flavor slurry. The dry matrix materials were subsequently dissolved into the flavor slurry using over-head mixer. The slurry was heated to 50-55° C. to ensure all the fat present in the reaction flavor was fully melted. The mixture was then subjected to high shear mixing at 6000 rpm for 5 minutes using a Silverson high shear mixture. While maintaining the temperature at 50-55° C., the flavor slurry was homogenized using a Silverson Verso in line rotor-stator mixer at 2500 rpm and circulation rate of 1 Kg per minute. The flavor slurry was then spray dried using a pilot scale Anhydro MicraSpray MS-400 spray dryer with a centrifugal atomizer installed. The inlet temperature was approximately 190° C. and the outlet temperature approximately 90° C.

TABLE 11

| Material | Gram |
|---|---|
| Sunflower Protein | 200 |
| Salt | 500 |
| Chicory Root Inulin | 300 |
| Chicken reaction flavor | 1600 |
| Water | 2400 |

Table 12 summarizes the physicochemical properties of chicken reaction spray dried powder. The flavor powder prepared using combination of sunflower protein, salt, and chicory root contained approximately 50% flavor on a dry basis.

TABLE 12

| Flavor emulsion mean droplet size | <10 µm |
|---|---|
| Flavor emulsion viscosity | 37 cps |
| Microcapsule mean particle size | 38.9 µm |
| Microcapsule water activity | 0.143 |

What is claimed is:

1. An encapsulation particle comprising:
(a) an active material; and
(b) a matrix material containing an unhydrolyzed rice, sunflower, or faba bean protein and carrier,
wherein the encapsulation particle has a diameter of 2 µm to 5000 µm, the active material is dispersed within the matrix material, and the ratio between the active material and the unhydrolyzed rice, sunflower, or faba bean protein is 10:1 to 1:10.

2. The encapsulation particle of claim 1, wherein the carrier is present in an amount of 1% to 99% by weight of the encapsulation particle.

3. The encapsulation particle of claim 1 or 2, wherein the carrier is inulin, maltodextrin, glycose syrup solid, maltose, sucrose, polyol, vegetable fiber or a combination thereof.

4. The encapsulation particle of any one of claims 1 to 3, wherein the active material is selected from the group consisting of a fragrance, pro-fragrance, flavor, malodor counteractive agent, vitamin or derivative thereof, antiinflammatory agent, fungicide, anesthetic, analgesic, antimicrobial active, anti-viral agent, anti-infectious agent, anti-acne agent, skin lightening agent, insect repellant, animal repellent, vermin repellent, emollient, skin moisturizing agent, wrinkle control agent, UV protection agent, fabric softener active, hard surface cleaning active, skin or hair conditioning agent, flame retardant, antistatic agent, taste modulator, cell, probiotic, colorant, vegetable oil, and combinations thereof.

5. The encapsulation particle of any one of claims 1 to 4, wherein the active material is present in an amount of 0.1% to 60% by weight of the encapsulation particle.

6. The encapsulation particle of any one of claims 1 to 5, wherein the unhydrolyzed rice, sunflower, or faba bean protein is present in an amount of 0.1% to 99% by weight of the encapsulation particle.

7. A method for producing an encapsulation particle comprising:
(a) emulsifying an active material, an unhydrolyzed rice, sunflower, or faba bean protein and a carrier to obtain a homogeneous aqueous slurry, wherein the active material and the unhydrolyzed rice, sunflower, or faba bean protein are provided at a ratio of 10:1 to 1:10; and
(b) drying the homogeneous aqueous slurry, thereby producing an encapsulation particle.

8. The method of claim 7, wherein the active material is a flavor.

9. The method of claim 7, wherein the homogeneous aqueous slurry is dried by spray drying, freeze drying, spray chilling, fluidized bed drying, drum drying, vacuum drying, film drying, belt drying, conduction drying, infrared drying, or a combination thereof.
